(19) United States
(12) Patent Application Publication
(10) Pub. No.: US 2024/0200940 A1
(43) Pub. Date: Jun. 20, 2024

(54) ACCELERATION DETECTION DEVICE AND MOUNTING ANGLE DETECTION METHOD

(71) Applicant: DENSO CORPORATION, Kariya-city (JP)

(72) Inventors: CHAO CHEN, Kariya-city (JP); NAOKI YOSHIDA, Kariya-city (JP)

(21) Appl. No.: 18/416,575

(22) Filed: Jan. 18, 2024

Related U.S. Application Data
(63) Continuation of application No. PCT/JP2022/025337, filed on Jun. 24, 2022.

(30) Foreign Application Priority Data
Jul. 22, 2021 (JP) 2021-121108

(51) Int. Cl. G01B 21/22; G01P 15/18

(52) U.S. Cl. CPC G01B 21/22; G01P 15/18

(57) ABSTRACT

An acceleration detection device includes an acceleration sensor that has a first detection axis and a second detection axis orthogonal to each other such that a yaw mounting angle between a vehicle reference axis and a virtual line is ±15 degrees or less, an acquisition section that acquires an acceleration in a direction of the first detection axis and an acceleration in a direction of the second detection axis, and a mounting angle calculation section that calculates the yaw mounting angle from an angle calculation formula.

### CROSS REFERENCE TO RELATED APPLICATIONS

The present application is a continuation application of International Patent Application No. PCT/JP2022/025337 filed on Jun. 24, 2022 which designated the U.S. and claims the benefit of priority from Japanese Patent Application No. 2021-121108 filed on Jul. 22, 2021. The entire disclosures of all of the above applications are incorporated herein by reference.

### TECHNICAL FIELD

The present disclosure relates to an acceleration detection device and a mounting angle detection method for detecting a mounting angle of an acceleration sensor.

### BACKGROUND

A related art discloses a technique of calculating an angle (hereinafter, yaw mounting angle θy) between a vehicle front-rear direction axis and a sensor x-axis, based on θy=sin⁻¹ (—A_{SY}/A_{BX}). In the above equation, A_{SY} is an acceleration in a sensor y-axis direction detected by an acceleration sensor, and A_{BX} is an acceleration in a vehicle front direction. The acceleration A_{BX} in the vehicle front-rear direction is calculated from a change in speed in the vehicle front-rear direction detected by a speed sensor when the vehicle is traveling straight on a horizontal plane.

### SUMMARY

One example of the present disclosure, an acceleration detection device includes an acceleration sensor that has a first detection axis and a second detection axis orthogonal to each other such that a yaw mounting angle between a vehicle reference axis and a virtual line is ±15 degrees or less, an acquisition section that acquires an acceleration in a direction of the first detection axis and an acceleration in a direction of the second detection axis, and a mounting angle calculation section that calculates the yaw mounting angle from an angle calculation formula.

### BRIEF DESCRIPTION OF DRAWINGS

FIG. 1 is a diagram illustrating directions of an sx-axis and an sy-axis included in an acceleration sensor.

FIG. 2 is a diagram illustrating a direction of an sz-axis included in the acceleration sensor.

FIG. 3 is a diagram illustrating a configuration of an acceleration detection device.

FIG. 4 is a diagram illustrating equations in a process of deriving an angle calculation formula.

FIG. 5 is a diagram illustrating a flow of processing until a yaw mounting angle Δθ is calculated in a first embodiment.

FIG. 6 is a diagram illustrating a configuration of an acceleration detection device of a second embodiment.

FIG. 7 is a diagram illustrating an angle calculation formula used in the second embodiment.

FIG. 8 is a diagram illustrating a flow of processing until a yaw mounting angle Δθ is calculated in the second embodiment.

FIG. 9 is a diagram illustrating directions of an acceleration A by Aₛₓ+A_{sy} and Aₛₓ−A_{sy}.

FIG. 10 is a view illustrating a mounting direction of the acceleration sensor of a third embodiment.

FIG. 11 is a diagram illustrating equations in a process of deriving an angle calculation formula used in the third embodiment.

FIG. 12 is a view illustrating a mounting direction of the acceleration sensor of a fourth embodiment.

FIG. 13 is a diagram illustrating equations in a process of deriving an angle calculation formula used in the fourth embodiment.

FIG. 14 is a view illustrating a mounting direction of the acceleration sensor of a fifth embodiment.

FIG. 15 is a diagram illustrating equations in a process of deriving an angle calculation formula used in the fifth embodiment.

FIG. 16 is a diagram illustrating equations in a process of deriving an angle calculation formula used in a sixth embodiment.

### DETAILED DESCRIPTION

Because the acceleration sensor is fixed to the casing, the yaw mounting angle θy of the acceleration sensor can also be determined by the technique disclosed in a related art. However, it is necessary to calculate the acceleration A_{BX} in the vehicle front-rear direction from the change in speed in the vehicle front-rear direction detected by the speed sensor when the vehicle is traveling straight on a horizontal plane. Therefore, in a case where the vehicle and the acceleration sensor is inclined with respect to the horizontal plane, for example, in a case where the road surface on which the vehicle is traveling is inclined, the calculation accuracy of the yaw mounting angle θy is lower.

The present disclosure provides an acceleration detection device and a mounting angle detection method capable of accurately detecting a mounting angle of an acceleration sensor.

According to one aspect of the present disclosure, an acceleration detection device mounted on a vehicle is provided. The acceleration detection device comprises an acceleration sensor that has at least a first detection axis and a second detection axis orthogonal to each other and is mounted on the vehicle such that a yaw mounting angle between a vehicle reference axis that is either a vehicle front-rear direction axis or a vehicle width direction axis and a virtual line set between the first detection axis and the second detection axis is ±15 degrees or less, an acquisition section that is configured to acquire, from the acceleration sensor, an acceleration in a direction of the first detection axis and an acceleration in a direction of the second detection axis in a state where acceleration in the vehicle width direction is generated in the vehicle and low acceleration or low deceleration is generated in the vehicle front-rear direction; and a mounting angle calculation section that is configured to calculate the yaw mounting angle from an angle calculation formula that calculates the yaw mounting angle from an acceleration in the direction of the first detection axis and an acceleration in the direction of the second detection axis and the acceleration in the direction of the first detection axis and the acceleration in the direction of the second detection axis detected by the acquisition section, the angle calculation formula being derived by assuming a state where acceleration in the vehicle width direction is generated in the vehicle and no acceleration is generated in the vehicle front-rear direction and by using a fact that a tan value of the yaw mounting angle is approximated to the yaw mounting angle.

When assuming that the acceleration sensor is disposed as described above and that no acceleration is generated in the vehicle front-rear direction, and using the fact that the tan value of the yaw mounting angle can be approximated to the yaw mounting angle, it is possible to derive the angle calculation formula for calculating the yaw mounting angle from the acceleration in the first detection axis direction and the acceleration in the second detection axis direction.

Therefore, the mounting angle calculation section calculates the yaw mounting angle from (i) the acceleration in the first detection axis direction and the acceleration in the second detection axis direction acquired by the acquisition section in a state where acceleration is generated in the vehicle width direction and a low acceleration is generated in the vehicle front-rear direction is generated and (ii) the above-mentioned angle calculation formula.

The angle calculation formula is a formula derived assuming a state where acceleration is generated in the vehicle width direction and no acceleration is generated in the vehicle front-rear direction. When the vehicle is inclined in the vehicle width direction, acceleration caused by the inclination in the vehicle width direction of the vehicle is applied along the first detection axis and the second detection axis. However, the angle calculation formula is a formula assuming that acceleration is generated in the vehicle width direction. Therefore, even in a case where the first detection axis and the second detection axis of the acceleration sensor are inclined in the vehicle width direction with respect to the horizontal plane for, for example, a reason that the road surface on which the vehicle is traveling is inclined in the vehicle width direction, a decrease in a calculation accuracy of the yaw mounting angle is prevented or reduced.

According to one aspect of the present disclosure, a mounting angle detection method for detecting a mounting angle of an acceleration sensor that has at least a first detection axis and a second detection axis orthogonal to each other and is disposed on a vehicle such that a yaw mounting angle between a vehicle reference axis that is either a vehicle front-rear direction axis or a vehicle width direction axis and a virtual line set between the first detection axis and the second detection axis is ±15 degrees or less is provided. The method comprises: acquiring, from the acceleration sensor, an acceleration in a direction of the first detection axis and an acceleration in a direction of the second detection axis in a state where acceleration in the vehicle width direction is generated in the vehicle and low acceleration or low deceleration is generated in the vehicle front-rear direction; and calculating the yaw mounting angle from an angle calculation formula that calculates the yaw mounting angle from an acceleration in the direction of the first detection axis and an acceleration in the direction of the second detection axis and the acceleration in the direction of the first detection axis and the acceleration in the direction of the second detection axis acquired, the angle calculation formula being derived by assuming a state where acceleration in the vehicle width direction is generated in the vehicle and no acceleration is generated in the vehicle front-rear direction and by using a fact that a tan value of the yaw mounting angle is approximated to the yaw mounting angle.

### First Embodiment

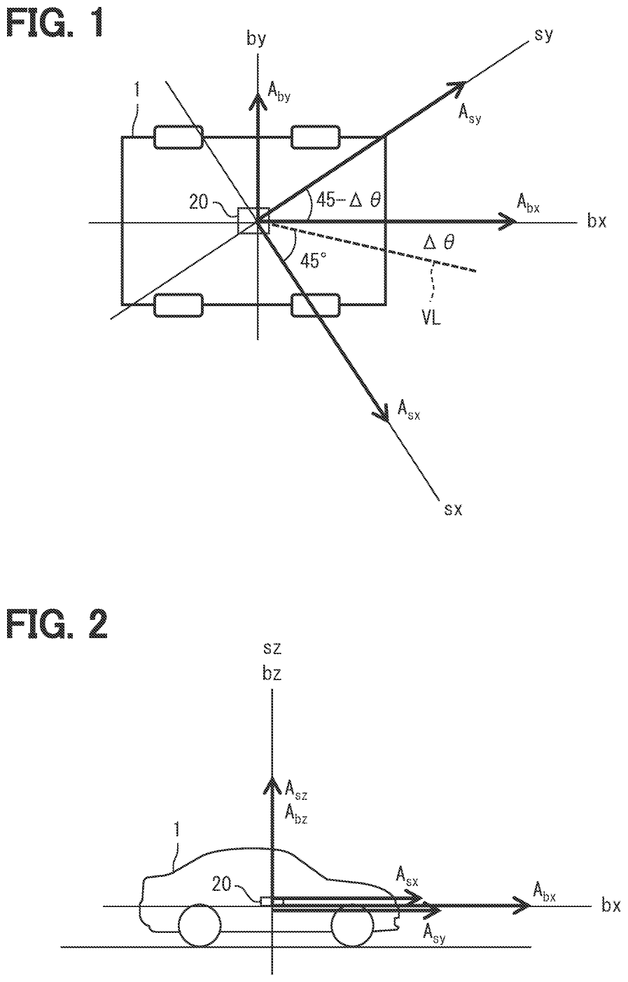

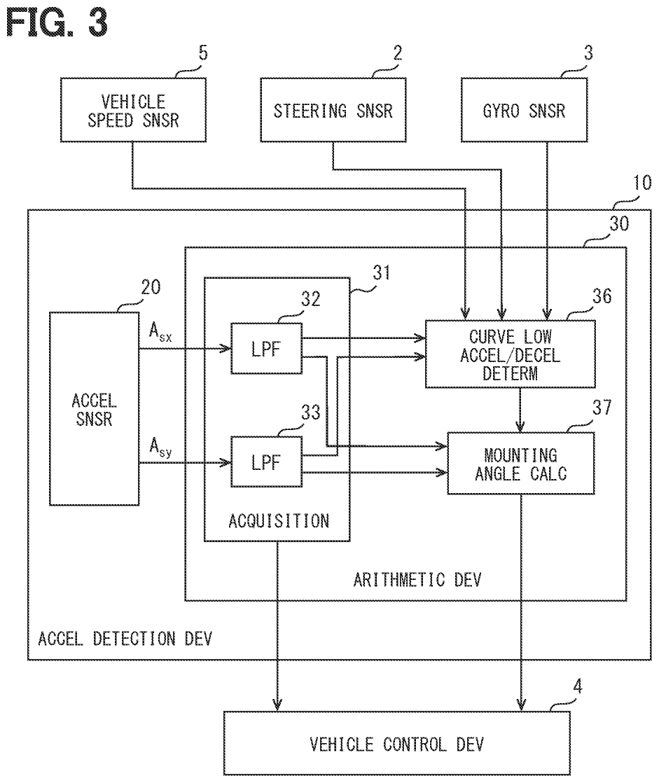

Hereinafter, an embodiment will be described with reference to the drawings. FIG. 1 is a diagram illustrating directions of an sx-axis and an sy-axis of an acceleration sensor 20 included in an acceleration detection device 10 (see FIG. 3) of the present embodiment. The acceleration sensor 20 is mounted on a vehicle 1. A front-rear direction of the vehicle 1 is a bx direction, and a vehicle width direction of the vehicle 1 is a by direction. An axis representing the bx direction may be referred to as a bx-axis, and an axis representing the by direction may be referred to as a by-axis. The bx-axis is a vehicle front-rear direction axis, and the by-axis is a vehicle width direction axis. As illustrated in FIG. 2, the vertical direction of the vehicle 1 is defined as a bz direction. An axis representing the bz direction is sometimes described as a bz-axis.

The sx-axis and the sy-axis included in the acceleration sensor 20 are axes representing directions in which the acceleration sensor 20 detects an acceleration A. The sx-axis that is a first detection axis and the sy-axis that is a second detection axis are in the same plane and orthogonal to each other. The acceleration sensor 20 also includes an sz-axis as illustrated in FIG. 2. The sz-axis is an axis orthogonal to the sx-axis and the sy-axis. The acceleration sensor 20 detects the acceleration A in each of the three axial directions.

As illustrated in FIGS. 1 and 2, the acceleration in each axial direction is denoted by “A” with a subscript indicating the axis. Therefore, the accelerations A_{bx}, A_{by}, and A_{bz} respectively represent the acceleration A in the bx-axis, by-axis, and bz-axis directions. The accelerations Aₛₓ, A_{sy}, and A_{sz} respectively represent an acceleration A in the sx-axis direction (that is, the first detection axis direction), an acceleration A in the sy-axis direction (that is, the second detection axis direction), and an acceleration A in the sz-axis direction.

The sx-axis and the sy-axis are disposed along a vehicle plane including the front-rear direction and the left-right direction of the vehicle 1. The vehicle plane includes the bx-axis and the by-axis. However, it is difficult to mount the acceleration sensor 20 on the vehicle 1, via a casing or the like in which the acceleration sensor 20 is accommodated, such that a plane (hereinafter, a sensor plane) including the sx-axis and the sy-axis of the acceleration sensor 20 is completely parallel to the vehicle plane. If the sensor plane and the vehicle plane are substantially parallel, it can be said that the sensor plane is along the vehicle plane. However, when the sensor plane and the vehicle plane are not parallel, the bz-axis and the sz-axis do not coincide with each other.

Therefore, after the acceleration sensor 20 is mounted on the vehicle 1, misalignment between the bz-axis and the sz-axis is detected, whereby the acceleration A_{sz} is corrected and used to control the vehicle. The misalignment between the bz-axis and the sz-axis can be detected by detecting the deviation between the direction of a gravity vector and the sz-axis.

It is also difficult to mount the acceleration sensor 20 such that the sx-axis and the sy-axis of the acceleration sensor 20 strictly coincide with predetermined directions of the vehicle 1. However, unlike the misalignment between the bz-axis and the sz-axis, it is difficult to detect, by using the gravity vector, the misalignment between the sx-axis and the bx-axis and the misalignment between the sy-axis and the by-axis.

To address this issue, in the acceleration detection device 10 of the present embodiment, a virtual line VL is set between the sx-axis and the sy-axis of the acceleration sensor 20. The virtual line VL of the present embodiment bisects the space between the sx-axis and the sy-axis on the same plane as the plane on which the sx-axis and the sy-axis are on. The acceleration sensor 20 is mounted on the vehicle 1 such that an angle (hereinafter, a yaw mounting angle) 40 between the virtual line VL and the bx-axis is ±15° or less with the bx-axis as a vehicle reference axis.

Although it is difficult to mount the acceleration sensor 20 on the vehicle 1 such that the yaw mounting angle Δθ is 0°, it is easy to mount the acceleration sensor 20 on the vehicle 1 such that the yaw mounting angle Δθ is ±15° or less. When the acceleration sensor 20 is mounted on the vehicle 1 such that the yaw mounting angle Δθ is ±15° or less, it is easy to calculate the yaw mounting angle Δθ as described below. If the yaw mounting angle Δθ can be calculated, the directions of the sx-axis and the sy-axis can also be calculated.

### [Configuration of Acceleration Detection Device 10]

FIG. 3 illustrates a configuration of the acceleration detection device 10. The acceleration detection device 10 includes the acceleration sensor 20 and an arithmetic device 30. Of the configuration included in the arithmetic device 30, FIG. 3 mainly illustrates a configuration for calculating the yaw mounting angle Δθ and omits the configuration unrelated to the configuration for calculating the yaw mounting angle Δθ.

The arithmetic device 30 can be implemented by a computer including a processor, a non-volatile memory, a random-access memory (RAM), an input/output (I/O), a bus line connecting these components, and the like. The arithmetic device 30 may include a hardware logic circuit in addition to the processor. The non-volatile memory stores a program for causing a general-purpose computer to operate as the arithmetic device 30. The processor executes the program stored in the non-volatile memory while using a temporary storage function of the RAM, so that the arithmetic device 30 implements the function as each section illustrated in FIG. 3. In addition, in a case where the arithmetic device 30 functions as each unit illustrated in FIG. 3, it means that a mounting angle detection method corresponding to the above-mentioned program is performed.

As illustrated in FIG. 3, the arithmetic device 30 functions as an acquisition section 31, a curve low acceleration/deceleration determination section 36, and a mounting angle calculation section 37. The acquisition section 31 acquires signals representing the accelerations Aₛₓ, A_{sy}, and A_{sz} of the three axes from the acceleration sensor 20. The acquisition section 31 sequentially outputs the signals representing the acquired accelerations Aₛₓ, A_{sy}, and A_{sz} to the vehicle control device 4. The vehicle control device 4 controls acceleration and deceleration of the vehicle 1 on the basis of the acceleration A, angular acceleration, and the like generated in the vehicle 1. The curve low acceleration/deceleration determination section 36 corresponds to a curve low acceleration and deceleration determination section.

The acquisition section 31 includes low-pass filters 32 and 33. The low-pass filter 32 allows a low-frequency component of the signal representing the acceleration Aₛₓ acquired from the acceleration sensor 20 to pass through. The low-pass filter 33 allows a low-frequency component of the signal representing the acceleration A_{sy} acquired from the acceleration sensor 20 to pass through. The low-pass filters 32 and 33 are provided to remove noise components from the signal representing the acceleration A. The low-pass filters 32 and 33 respectively output signals to the curve low acceleration/deceleration determination section 36 and the mounting angle calculation section 37.

The curve low acceleration/deceleration determination section 36 determines whether the vehicle 1 is traveling on a curve and is in a low acceleration/deceleration state. A detection value of a steering sensor 2 and a yaw angular velocity detection value of the gyro sensor 3 are input to the curve low acceleration/deceleration determination section 36. The detection value of the steering sensor 2 and the yaw angular velocity detection value of the gyro sensor 3 are curving travel determination signals for determining whether the vehicle 1 is traveling on a curve. Note that only one of the detection value of the steering sensor 2 and the detection value of the gyro sensor 3 may be input to the curve low acceleration/deceleration determination section 36 as the curving travel determination signal. Although FIG. 3 illustrate the state where the gyro sensor 3 is not included in the acceleration detection device 10, the gyro sensor 3 may be integrated with the acceleration sensor 20 included in the acceleration detection device 10.

A signal representing a vehicle speed of the vehicle 1 is also input from a vehicle speed sensor 5 to the curve low acceleration/deceleration determination section 36. The curve low acceleration/deceleration determination section 36 calculates the acceleration A from a change in the vehicle speed. The acceleration A means an acceleration A in the traveling direction of the vehicle 1. The curve low acceleration/deceleration determination section 36 determines whether the vehicle 1 is in a low acceleration/deceleration state, on the basis of the acceleration A calculated from a temporal change in the vehicle speed. Whether the vehicle 1 is in the low acceleration/deceleration state is determined based on whether the acceleration A of the vehicle 1 is within a previously set low acceleration/deceleration range. The low acceleration/deceleration range is a range determined from the viewpoint of whether Equation (6) and (7) to be described later are satisfied, and is a range set in advance on the basis of experiments or the like.

The mounting angle calculation section 37 calculates the yaw mounting angle Δθ by using the signals representing the accelerations Aₛₓ and A_{sy} output from the low-pass filters 32 and 33 and using an angle calculation formula described below. The mounting angle calculation section 37 outputs the calculated yaw mounting angle Δθ to the vehicle control device 4. The vehicle control device 4 corrects the accelerations Aₛₓ and A_{sy} output from the acquisition section 31 by using the yaw mounting angle Δθ and uses the corrected accelerations for vehicle control.

### [Angle Calculation Formula]

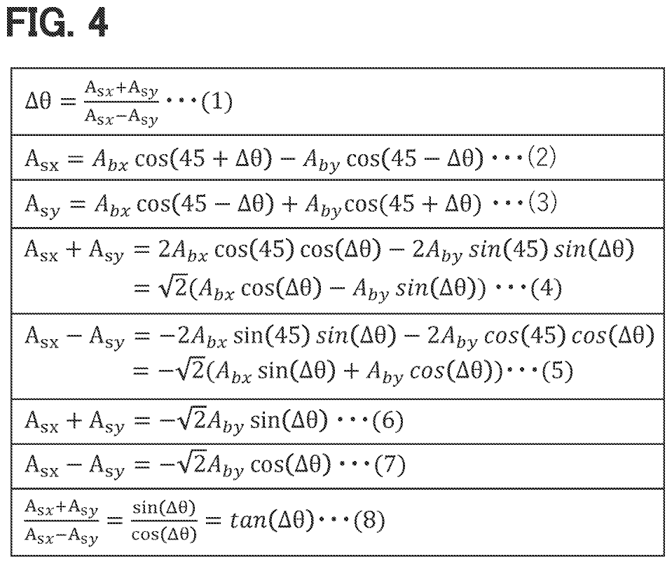

Next, the angle calculation formula will be described. In the present embodiment, Equation (1) shown in FIG. 4 is used as the angle calculation formula. A method for deriving Equation (1) will be described below. Equations (2) and (3) shown in FIG. 4 are established based on the geometric relation illustrated in FIG. 1.

The left sides of Equations (2) and (3) and the right sides of Equations (2) and (3) are each added together, and the right side of the result is deformed by using the addition theorem, whereby Equation (4) is obtained. In addition, the left side and the right side of Equation (3) are respectively subtracted from the left side and the right side of Equation (2), and the right side of the result is deformed using the addition theorem, whereby Equation (5) is obtained. The angle calculation formula shown by Equation (1) assumes that the acceleration A_{bx} in the vehicle front-rear direction is sufficiently smaller than the acceleration A_{by} in the vehicle width direction, such as a case where the vehicle 1 is traveling at a constant speed on a curve. In other words, the angle calculation formula shown in Equation (1) assumes a state where the acceleration A_{bx} in the vehicle front-rear direction is an acceleration A that is small enough to consider that substantially no acceleration is generated. When this assumption is applied to Equations (4) and (5), the first terms in the parentheses can be eliminated in Equations (4) and (5), and Equations (6) and (7) are obtained. By using Equations (6) and (7), the calculation shown in Equation (8) can be further performed.

In the present embodiment, the acceleration sensor 20 is mounted such that the yaw mounting angle Δθ is ±15° or less. When the yaw mounting angle Δθ is ±15° or less, tan θ can be approximated as tan θ=θ (rad). This is because tan(15π/180) is approximately 0.259, and 15° is 0.261 (rad). When tan θ≈θ is applied to Equation (8), Equation (1) is obtained.

### [Flow of Processing]

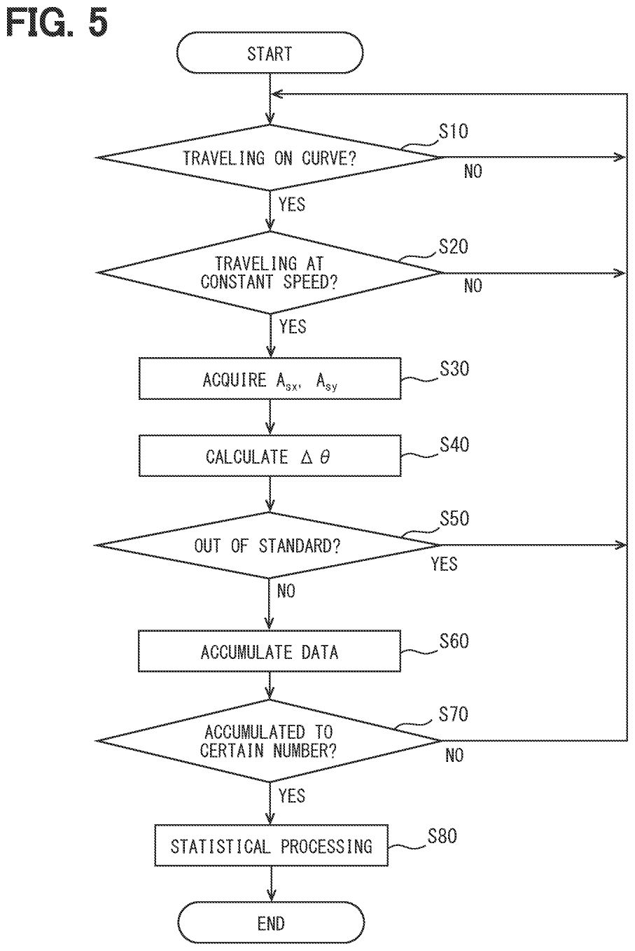

FIG. 5 illustrates a flow of processing until the yaw mounting angle Δθ is calculated. The processing illustrated in FIG. 5 can be performed at the time of traveling of the vehicle 1 in a case where the yaw mounting angle Δθ is not calculated. Alternatively, even in a case where the yaw mounting angle Δθ is calculated, the yaw mounting angle Δθ may be calculated at the time of traveling of the vehicle 1 when a certain period of time has elapsed after the yaw mounting angle Δθ was calculated.

In step S10, the curve low acceleration/deceleration determination section 36 determines whether the vehicle 1 is traveling on a curve, by using one or both of the detection value of the steering sensor 2 and the yaw angular velocity detection value of the gyro sensor 3. When the detection value of the steering sensor 2 indicates that the steering angle is greater than or equal to an angular threshold indicating curve traveling, it can be determined that the vehicle 1 is traveling on a curve. When the yaw angular velocity detection value indicates that the yaw angular velocity is greater than or equal to an angular velocity threshold, it may be determined that the vehicle 1 is traveling on a curve. The angular threshold and the angular velocity threshold are values set in advance.

When a determination result of step S10 is NO, the determination in step S10 is repeated. When the determination result of step S10 is YES, the process proceeds to step S20. In step S20, the curve low acceleration/deceleration determination section 36 calculates the acceleration A from the temporal change in the vehicle speed. Then, on the basis of the acceleration A, it is determined whether the vehicle 1 is traveling at a constant speed. When the acceleration A calculated from the vehicle speed is within the previously set low acceleration/deceleration range, it is determined that the vehicle 1 is traveling at a constant speed. It can be said that this determination is a determination on whether the vehicle 1 is in the low acceleration/deceleration state. When the determination result of step S20 is NO, the process returns to step S10. When the determination result of step S20 is YES, the process proceeds to step S30.

In step S30, the acquisition section 31 acquires the accelerations Aₛₓ and A_{sy} from the acceleration sensor 20. In step S40, the curve low acceleration/deceleration determination section 36 substitutes the accelerations Aₛₓ and A_{sy} acquired in step S30 into Equation (1) to calculate the yaw mounting angle ΔΘ.

In step S50, the mounting angle calculation section 37 determines whether the yaw mounting angle Δθ calculated in step S40 is out of standard. For example, when the yaw mounting angle Δθ calculated in step S40 is out of the range of ±15°, the yaw mounting angle Δθ is determined to be out of standard. When the determination result of step S50 is YES, the process returns to step S10. When the determination result of step S50 is NO, the process proceeds to step S60.

In step S60, the mounting angle calculation section 37 accumulates the yaw mounting angle Δθ calculated in step S40. In step S70, the mounting angle calculation section 37 determines whether the number of the accumulated yaw mounting angles 40 has reached a certain number. When the determination result of step S70 is NO, the process returns to step S10. When the determination result of step S70 is YES, the process proceeds to step S80. The certain number is a value determined in advance, and is a number for ensuring accuracy required in statistical processing in step S80.

In step S80, the mounting angle calculation section 37 performs statistical processing on the data accumulated in step S60 to calculate the yaw mounting angle Δθ. In an example of the statistical processing, a mode value of the accumulated yaw mounting angles 40 can be adopted. In another example of the statistical processing, dots are plotted with Aₛₓ−Δ_{sy} as the horizontal axis and with Δₛₓ+Δ_{sy} as the vertical axis, and an approximate straight line of these dots is calculated. On the basis of Equation (1), the slope of the approximate straight line is the yaw mounting angle Δθ. The mounting angle calculation section 37 outputs the yaw mounting angle Δθ obtained by the statistical processing to the vehicle control device 4.

The vehicle control device 4 can calculate the directions of the sx-axis and the sy-axis on the basis of the yaw mounting angle Δθ. However, the arithmetic device 30 may also calculate the directions of the sx-axis and the sy-axis and output the calculated directions to the vehicle control device 4.

In the first embodiment described above, the virtual line VL is set between the sx-axis and the sy-axis. If it is assumed that the acceleration A_{bx} in the vehicle front-rear direction is sufficiently smaller than the acceleration A_{by} in the vehicle width direction, it is possible to derive the angle calculation formula (Equation (1)) for calculating the yaw mounting angle Δθ between the virtual line VL and the bx-axis, which is the vehicle front-rear direction axis.

The angle calculation formula is a formula derived assuming a state where the acceleration A_{by} is generated in the vehicle width direction and the acceleration A_{bx} is not generated in the vehicle front-rear direction. When the vehicle 1 is inclined in the vehicle width direction, the acceleration A caused by the inclination of the vehicle 1 in the vehicle width direction is applied along the sx-axis and the sy-axis. However, the angle calculation formula is a formula assuming that the acceleration A is generated in the vehicle width direction. Therefore, even in a case where the sx-axis and the sy-axis of the acceleration sensor 20 are inclined in the vehicle width direction with respect to the horizontal plane for, for example, a reason that the road surface on which the vehicle is traveling is inclined in the vehicle 1 width direction, a decrease in a calculation accuracy of the yaw mounting angle Δθ is prevented or reduced.

The virtual line VL bisects between the sx-axis and the sy-axis. When the acceleration sensor 20 is mounted such that the yaw mounting angle Δθ between the virtual line VL and the bx-axis is ±15° or less, the angle between each of the sx-axis and the sy-axis and the bx-axis is close to 45°. As a result, it is possible to prevent or reduce the chance that one of Aₛₓ and A_{sy} to be substituted into Equation (1) becomes extremely small, the yaw mounting angle Δθ can be calculated more accurately.

In addition, the acceleration detection device 10 includes the curve low acceleration/deceleration determination section 36. The accelerations Aₛₓ and A_{sy} when the curve low acceleration/deceleration determination section 36 determines that the vehicle 1 is in a curve traveling state and is in the low acceleration/deceleration state are not used as the data for calculating the yaw mounting angle Δθ. Also by this processing, the yaw mounting angle Δθ can be accurately calculated.

The curving travel determination signals that the curve low acceleration/deceleration determination section 36 uses to determine whether the vehicle 1 is in a curve traveling state are the detection value of the steering sensor 2 and the yaw angular velocity detection value of the gyro sensor 3. Whether the vehicle 1 is traveling at a constant speed is determined from the acceleration obtained by differentiating the vehicle speed. Therefore, even when the acceleration sensor 20 is in a state where an abnormal value is detected, it is possible to prevent or reduce erroneous calculation of the yaw mounting angle Δθ using the abnormal value.

### Second Embodiment

Next, a second embodiment will be described. In the description of the second embodiment and subsequent embodiments, elements having the same reference signs as the already used reference signs are the same elements as the elements shown in the previous embodiments and having the same reference signs unless otherwise specified. In the case where only a part of the configuration is described, previously described other embodiments can be applied to the other part of the configuration.

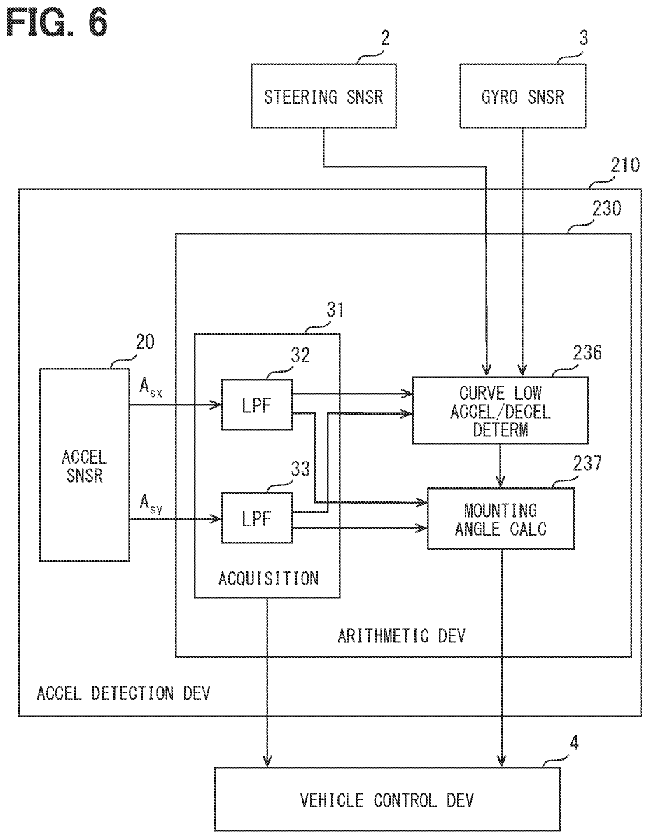

FIG. 6 illustrates a configuration of an acceleration detection device 210 of the second embodiment. As for the acceleration detection device 210, processing performed by a curve low acceleration/deceleration determination section 236 is different from the processing of the curve low acceleration/deceleration determination section 36 of the first embodiment. Similarly to the curve low acceleration/deceleration determination section 36, the curve low acceleration/deceleration determination section 236 determines whether the vehicle 1 is traveling on a curve by using at least one of the detection value of the steering sensor 2 and the yaw angular velocity detection value of the gyro sensor 3. However, whether the vehicle is in the low acceleration/deceleration state is determined using the acceleration A detected by the acceleration sensor 20. Therefore, the curve low acceleration/deceleration determination section 236 does not acquire the signal from the vehicle speed sensor 5. In the second embodiment, the angle calculation formula that a mounting angle calculation section 237 uses is different from the formula of the first embodiment. The curve low acceleration/deceleration determination section 236 corresponds to a curve low acceleration and deceleration determination section.

### [Angle Calculation Formula]

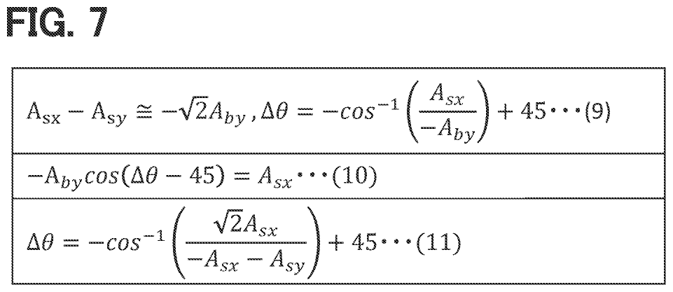

Next, the angle calculation formula used in the second embodiment will be described. In the second embodiment, Equation (9) shown in FIG. 7 is used as the angle calculation formula. A method for deriving Equation (9) will be described below. In Equation (5) shown in FIG. 4, A_{by}=0 is assumed similarly to the first embodiment. When the yaw mounting angle Δθ is ±15° or less, tan θ can be approximated as tan θ=1 (rad). From the above, the formula on the left side of Equation (9) is obtained from the Equation (5) shown in FIG. 4. In addition, Equation (10) shown in FIG. 7 is established based on the geometric relation illustrated in FIG. 1. When Expression (10) is deformed, the formula on the right side of Equation (9) is obtained.

Although Equation (9) includes two equations, when the equation on the left side is use to remove A_{by} in the equation on the right side, Equation (9) can be combined into one equation shown by Equation (11). As can be understood from Equation (11), the angle calculation formula of Equation (9) can also calculate the yaw mounting angle Δθ from the accelerations Aₛₓ and A_{sy}.

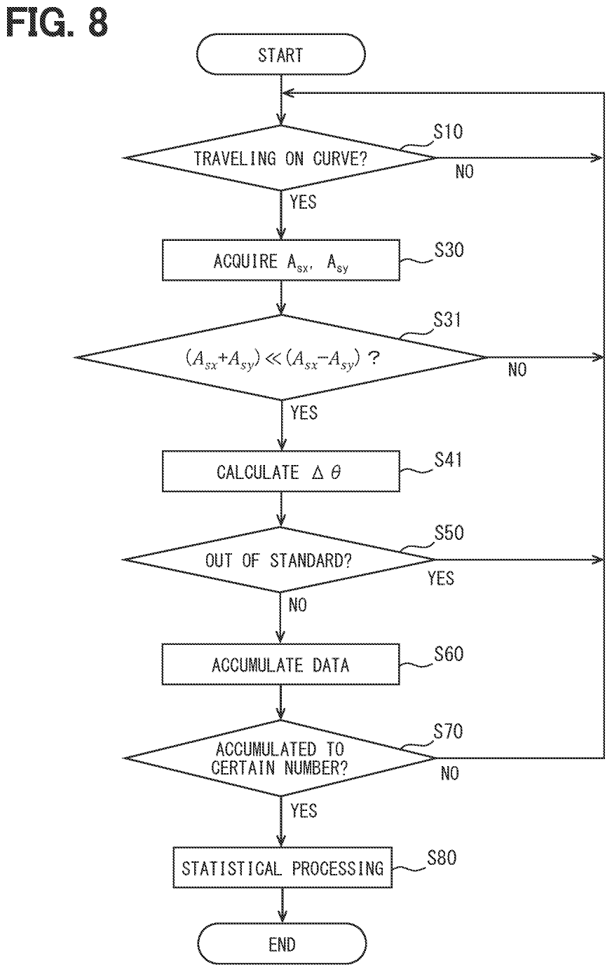

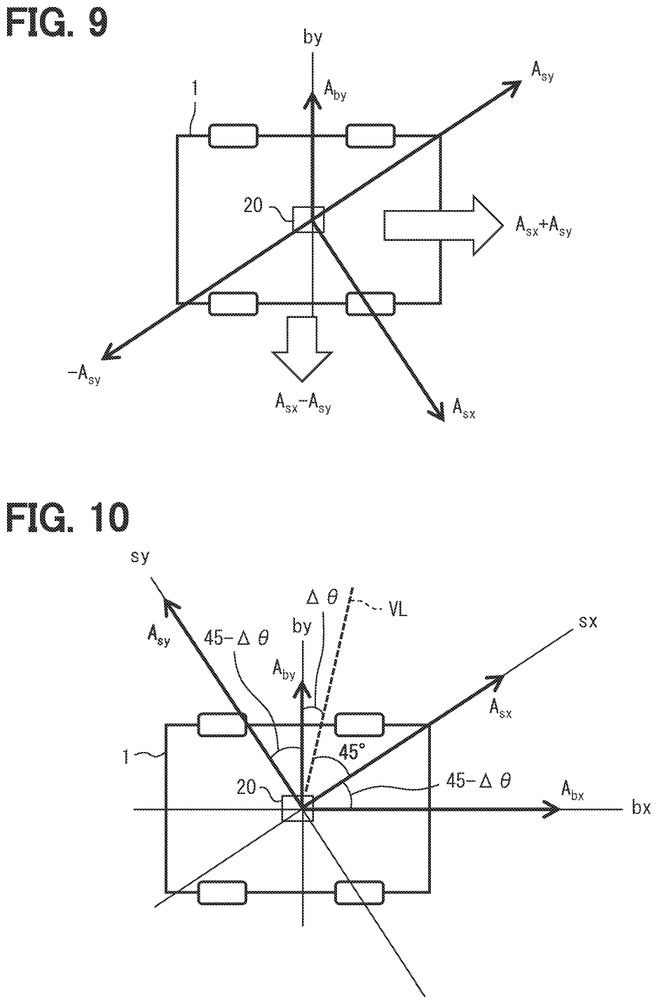

FIG. 8 illustrates a flow of processing until the yaw mounting angle Δθ is calculated in the second embodiment. FIG. 8 does not include step S20 of FIG. 5 and, instead, executes step S31. In step S31, the curve low acceleration/deceleration determination section 236 determines whether Aₛₓ+A_{sy} is sufficiently smaller than Aₛₓ−A_{sy} on the basis of the accelerations Aₛₓ and A_{sy} acquired in step S30. As illustrated in FIG. 9, Aₛₓ+A_{sy} is a substitute value for the acceleration A in the vehicle front-rear direction, and Aₛₓ−A_{sy} is a substitute value for the acceleration A in the vehicle width direction. In step S31, it is determined whether the acceleration A_{by} is generated and the acceleration A_{bx} is substantially 0, that is, whether the vehicle 1 is traveling on a curve.

Since the angle calculation formula is a formula calculated on the assumption that the acceleration A_{bx} is zero, it is determined whether the acceleration A_{bx} has a value close to zero also when acquiring the data to be substituted into the angle calculation formula. In a specific example of the determination in step S31, when Aₛₓ−A_{sy} is larger than Aₛₓ+A_{sy} by a predetermined value, the determination result of step S31 can be set to YES. Alternatively, when Aₛₓ−A_{sy} is greater than or equal to a predetermined multiple (eight times) of Aₛₓ+A_{sy}, the determination result of step S31 may be YES.

Alternatively, Aₛₓ cos α+A_{sy} cos (π/2−α) may be used instead of Aₛₓ+A_{sy}, and Aₛₓ cos (π/2−α)−A_{sy} cos α may be used instead of Aₛₓ−A_{sy}. The value a is an assumed angular difference between the sx-axis and the bx-axis.

When the determination result of step S31 is NO, step S10 is executed again. When the determination result of step S31 is YES, the process proceeds to step S41. In step S41, the mounting angle calculation section 237 substitutes the accelerations Aₛₓ and A_{sy} acquired in step S30 into the Equation (9) to calculate the yaw mounting angle Δθ.

In the second embodiment, it is determined whether the vehicle 1 is traveling at a constant speed on a curve, by using the output signal of the acceleration sensor 20 (step S31). When the determination is negative, the yaw mounting angle Δθ is not calculated. Therefore, it is possible to prevent or reduce the chance that the yaw mounting angle Δθ is calculated using the accelerations Aₛₓ and A_{sy} acquired in a situation different from the situation assumed in deriving the angular velocity calculation formula.

In addition, also in the second embodiment, it is determined whether the vehicle 1 is traveling on a curve, by using one or both of the detection value of the steering sensor 2 and the yaw angular velocity detection value of the gyro sensor 3. As a result, it is possible to further prevent or reduce the chance that the yaw mounting angle Δθ is calculated using the accelerations Aₛₓ and A_{sy} detected when the vehicle 1 is not traveling on a curve.

### Third Embodiment

In a third embodiment, the directions of the sx-axis and the sy-axis of the acceleration sensor 20 are different from those in the previous embodiments. As illustrated in FIG. 10, in the third embodiment, the acceleration sensor 20 is rotated counterclockwise by 90° about the sz-axis with respect to the direction of the first embodiment. The yaw mounting angle Δθ is an angle between the virtual line VL and the by-axis. In the third embodiment, the by-axis is the vehicle reference axis. The acceleration sensor 20 is mounted on the vehicle 1 such that an angle θ between the virtual line VL and the by-axis is ±15° or less.

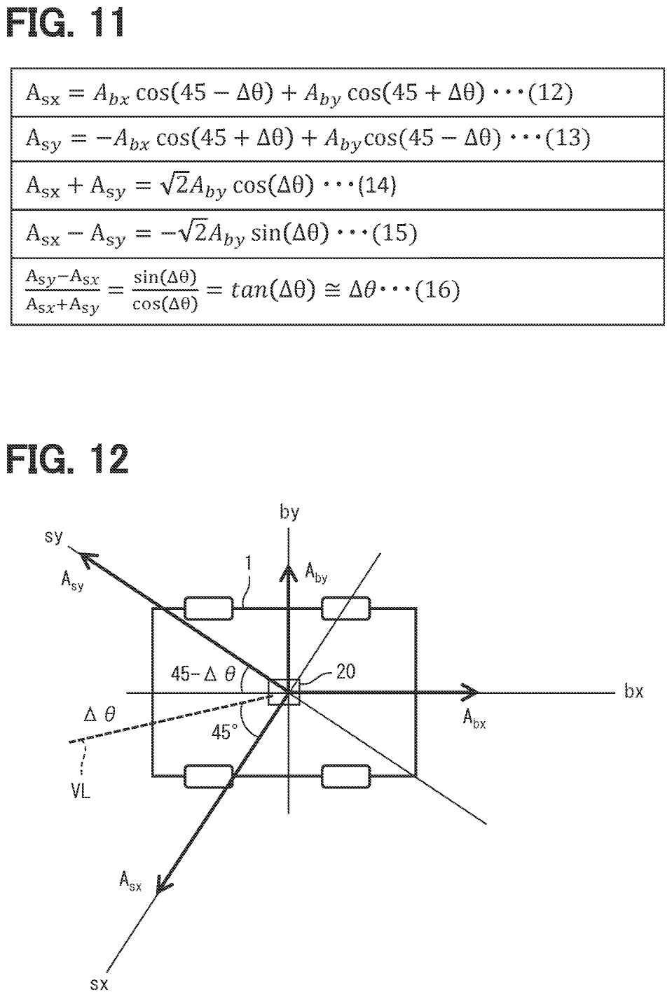

In the third embodiment, Equations (12) and (13) shown in FIG. 11 are established based on the geometric relation illustrated in FIG. 10. The left sides of Equations (12) and (13) and the right sides of Equations (12) and (13) are each added together, and the right side of the result is deformed by using the addition theorem, and A_{bx}=0 is substituted, whereby Equation (14) is obtained. In addition, the left side and the right side of Equation (13) are respectively subtracted from the left side and the right side of Equation (12), and the right side of the result is deformed using the addition theorem, and A_{bx}=0 is substituted, whereby Equation (15) is obtained. Furthermore, Equation (16), which is the angle calculation formula, is obtained from Equation (14) and an equation obtained by multiplying the both sides of Equation (15) by minus 1.

As described above, also when the acceleration sensor 20 is oriented as described in the third embodiment, the angle calculation formula for calculating the yaw mounting angle Δθ can be derived from the accelerations Aₛₓ and A_{sy}.

### Fourth Embodiment

In a fourth embodiment, as illustrated in FIG. 12, the acceleration sensor 20 is rotated by 180° about the sz-axis with respect to the direction of the first embodiment. The yaw mounting angle Δθ is an angle between the virtual line VL and the bx-axis similarly to the first embodiment.

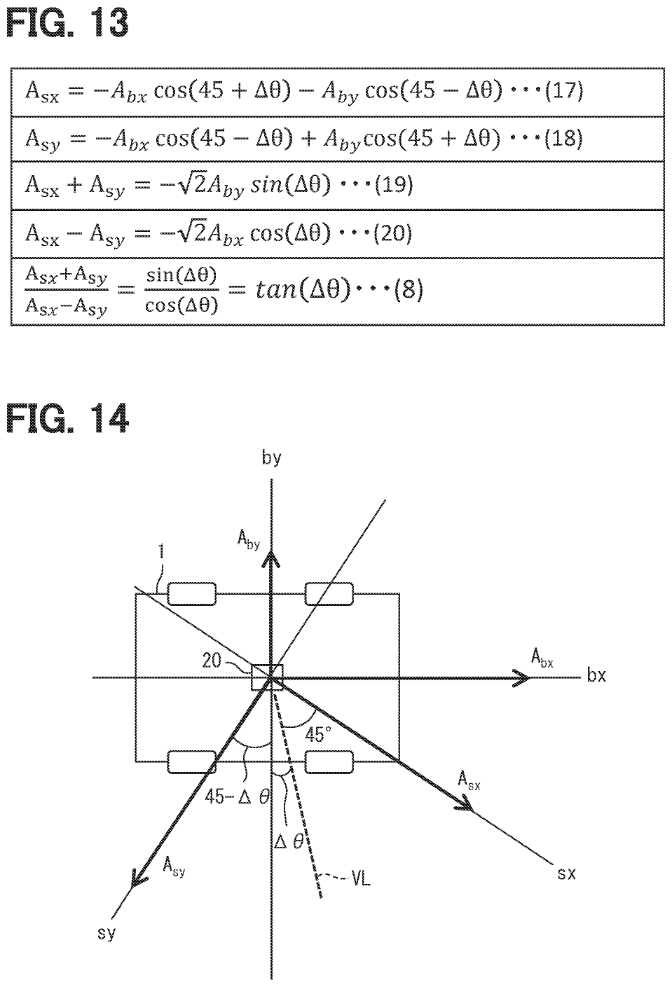

In the fourth embodiment, Equations (17) and (18) shown in FIG. 13 are established based on the geometric relation illustrated in FIG. 12. The left sides of Equations (17) and (18) and the right sides of Equations (17) and (18) are each added together, and the right side of the result is deformed by using the addition theorem, and A_{bx}=0 is substituted, whereby Equation (19) is obtained. In addition, the left side and the right side of Equation (18) are respectively subtracted from the left side and the right side of Equation (17), and the right side of the result is deformed using the addition theorem, and A_{bx}=0 is substituted, whereby Equation (20) is obtained. Furthermore, Equation (8), which is the same equation as that in the first embodiment, is obtained from Equations (19) and (20). Therefore, also in the fourth embodiment, the yaw mounting angle Δθ can be calculated using Equation (1) that is the same equation as that in the first embodiment, as the angle calculation formula.

### Fifth Embodiment

In a fifth embodiment, as illustrated in FIG. 14, the acceleration sensor 20 is rotated counterclockwise by 270° about the sz-axis with respect to the direction of the first embodiment. It can also be said that the acceleration sensor 20 is rotated by 180° about the sz-axis with respect to the third embodiment. The yaw mounting angle Δθ is an angle between the virtual line VL and the by-axis similarly to the third embodiment.

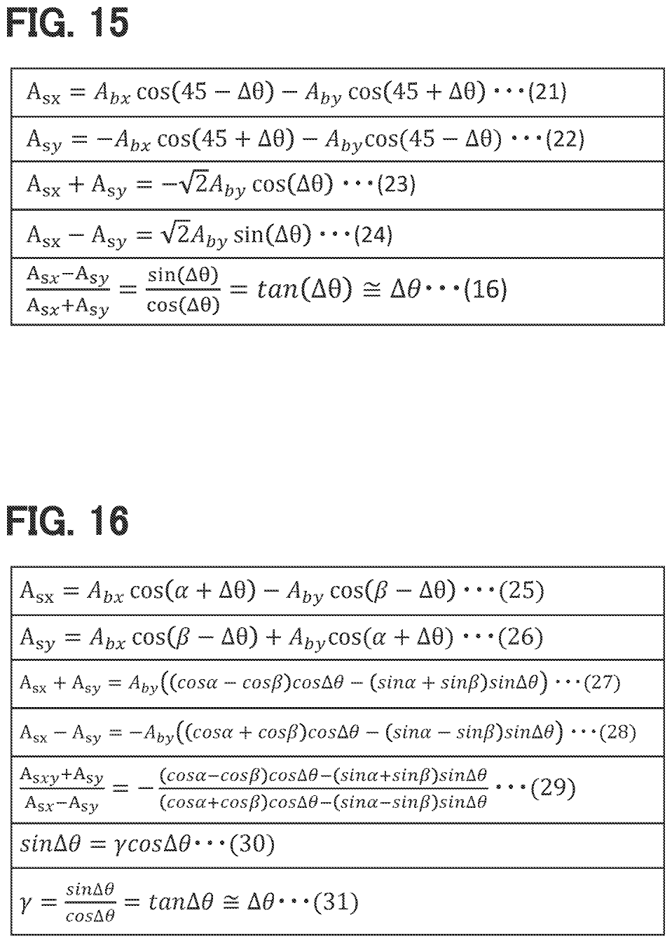

In the fifth embodiment, Equations (21) and (22) shown in FIG. 15 are established based on the geometric relation illustrated in FIG. 14. The left sides of Equations (21) and (22) and the right sides of Equations (21) and (22) are each added together, and the right side of the result is deformed by using the addition theorem, and A_{bx}=0 is substituted, whereby Equation (23) is obtained. In addition, the left side and the right side of Equation (22) are respectively subtracted from the left side and the right side of Equation (21), and the right side of the result is deformed using the addition theorem, and A_{bx}=0 is substituted, whereby Equation (24) is obtained. Furthermore, Equation (16), which is the same equation as that in the third embodiment, is obtained from Equation (23) and an equation obtained by multiplying the both sides of Equation (24) by minus 1. Therefore, in the fifth embodiment, the yaw mounting angle Δθ can be calculated using Equation (16) in the same manner as in the third embodiment.

### Sixth Embodiment

In the above embodiments, the virtual line VL is a line bisecting between the sx-axis and the sy-axis. However, the virtual line VL can be arbitrarily set between the sx-axis and the sy-axis. Assuming that the angle between the virtual line VL and the sx-axis is a and the angle between the virtual line VL and the sy-axis is β.

When Equations (2) and (3) are generalized using a and B, Equations (25) and (26) shown in FIG. 16 are obtained. Addition is performed on each of the right side of Equations (25) and (26) and the left sides of Equations (25) and (26), subtraction is performed on each of the right side of Equations (25) and (26) and the left sides of Equations (25) and (26), and A_{bx}=0 is substituted, whereby Equations (27) and (28) are obtained. Furthermore, Equation (29) is obtained from Equations (27) and (28). In Equation (29), numerical values are obtained except sin Δθ and cos Δθ. When the numerical values are calculated, Equation (30) is obtained. In Equation (30), γ is a numerical value. Equation (31) is further obtained from Equation (30). Since Equation (31) can be obtained, it is understood that the virtual line VL can be arbitrarily set between the sx-axis and the sy-axis.

Although the embodiments have been described above, the disclosed techniques are not limited to the above-described embodiments, and the following modifications are also included in the disclosed scope, and various modifications other than the followings can be made without departing from the gist.

### First Modification

As for the acceleration sensor 20, it is possible to separately include a sensor that detects the acceleration A in the sx-axis direction and a sensor that detects the acceleration A in the sy-axis direction. The acceleration sensor 20 may be a sensor including only an sx-axis and an sy-axis, instead of including three axes.

### Second Modification

Band-pass filters may be used instead of the low-pass filters 32 and 33. When the band-pass filters are used, it is easy to remove biases.

### Third Modification

In the second embodiment, it is determined in step S31 whether the vehicle is traveling at a constant speed, and, in addition, it is determined in step S10 whether the vehicle is traveling on a curve. However, the determination in step S10 may be omitted.

### Fourth Modification

In the second embodiment, Equation (1) may be used as the angle calculation formula. In the first embodiment, Equation (9) may be used as the angle calculation formula.

What is claimed is:

1. An acceleration detection device mounted on a vehicle, the acceleration detection device comprising:
an acceleration sensor that has at least a first detection axis and a second detection axis orthogonal to each other and is mounted on the vehicle such that a yaw mounting angle between a vehicle reference axis that is either a vehicle front-rear direction axis or a vehicle width direction axis and a virtual line set between the first detection axis and the second detection axis is ±15 degrees or less;
an acquisition section that is configured to acquire, from the acceleration sensor, an acceleration in a direction of the first detection axis and an acceleration in a direction of the second detection axis in a state where acceleration in the vehicle width direction is generated in the vehicle and low acceleration or low deceleration is generated in the vehicle front-rear direction; and
a mounting angle calculation section that is configured to calculate the yaw mounting angle from an angle calculation formula that calculates the yaw mounting angle from an acceleration in the direction of the first detection axis and an acceleration in the direction of the second detection axis and the acceleration in the direction of the first detection axis and the acceleration in the direction of the second detection axis detected by the acquisition section, the angle calculation formula being derived by assuming a state where acceleration in the vehicle width direction is generated in the vehicle and no acceleration is generated in the vehicle front-rear direction and by using a fact that a tan value of the yaw mounting angle is approximated to the yaw mounting angle.

2. The acceleration detection device according to claim 1, wherein
the virtual line bisects between the first detection axis and the second detection axis.

3. The acceleration detection device according to claim 1, further comprising
a curve low acceleration and deceleration determination section that is configured to determine, based on a curving travel determination signal that is different from an output signal of the acceleration sensor, whether the vehicle is traveling on a curve and determine, based on a change in a vehicle speed of the vehicle, whether the vehicle is in a low acceleration or deceleration state in the vehicle front-rear direction,
wherein
the mounting angle calculation section calculates the yaw mounting angle, based on a fact that the curve low acceleration and deceleration determination section determines that the vehicle is traveling on a curve and is in the low acceleration or deceleration state.

4. The acceleration detection device according to claim 1, further comprising
a curve low acceleration and deceleration determination section that is configured to determine, based on an output signal of the acceleration sensor, whether the vehicle is traveling on a curve and is in a low acceleration or deceleration state in the vehicle front-rear direction,
wherein
the mounting angle calculation section calculates the yaw mounting angle, based on a fact that the curve low acceleration and deceleration determination section determines that the vehicle is traveling on a curve and is in the low acceleration or deceleration state.

5. The acceleration detection device according to claim 4, wherein
the curve low acceleration and deceleration determination section determines whether the vehicle is traveling on a curve, based on a curving travel determination signal that is different from the output signal of the acceleration sensor.

6. A mounting angle detection method for detecting a mounting angle of an acceleration sensor that has at least a first detection axis and a second detection axis orthogonal to each other and is disposed on a vehicle such that a yaw mounting angle between a vehicle reference axis that is either a vehicle front-rear direction axis or a vehicle width direction axis and a virtual line set between the first detection axis and the second detection axis is ±15 degrees or less, the method comprising:
acquiring, from the acceleration sensor, an acceleration in a direction of the first detection axis and an acceleration in a direction of the second detection axis in a state where acceleration in the vehicle width direction is generated in the vehicle and low acceleration or low deceleration is generated in the vehicle front-rear direction; and
calculating the yaw mounting angle from an angle calculation formula that calculates the yaw mounting angle from an acceleration in the direction of the first detection axis and an acceleration in the direction of the second detection axis and the acceleration in the direction of the first detection axis and the acceleration in the direction of the second detection axis acquired, the angle calculation formula being derived by assuming a state where acceleration in the vehicle width direction is generated in the vehicle and no acceleration is generated in the vehicle front-rear direction and by using a fact that a tan value of the yaw mounting angle is approximated to the yaw mounting angle.
